(19) United States
(12) Patent Application Publication
(10) Pub. No.: US 2017/0055562 A1
(43) Pub. Date: Mar. 2, 2017

(54) MANAGEMENT OF PROPIONATE METABOLISM DISORDERS

(71) Applicant: D. Holmes Morton, Strasburg, PA (US)

(72) Inventor: D. Holmes Morton, Strasburg, PA (US)

(21) Appl. No.: 15/253,756

(22) Filed: Aug. 31, 2016

Related U.S. Application Data
(60) Provisional application No. 62/233,156, filed on Sep. 25, 2015.
(60) Provisional application No. 62/212,900, filed on Sep. 1, 2015.

(51) Int. Cl. A23L 33/00; A23L 2/52; A23L 33/175

(52) U.S. Cl. CPC A23L 33/30; A23L 33/175; A23L 2/52; A23V 2002/00

(57) ABSTRACT

Described is a nutritional formula, also referred to as a nutritional formulation, for dietary management of a propionic metabolism disorder, such as propionic acidemia.

### RELATED APPLICATIONS

This application claims the benefit under 35 U.S.C. 119(e) of U.S. provisional patent application No. 62/212,900 filed on Sep. 1, 2015, entitled “Management of Propionate Metabolism Disorders”, and U.S. provisional patent application No. 62/233,156, filed on Sep. 25, 2015, entitled “Management of Propionate Metabolism Disorders.” The entire teachings of both applications are incorporated by reference herein.

### BACKGROUND

Propionic acidemia (PA), also known as propionic aciduria, propionyl-CoA carboxylase deficiency and ketotic glycinemia, is an autosomal recessive metabolic disorder. Propionyl CoA carboxylase is inactive in affected individuals, who cannot process certain amino acids and fats; the condition leads to an abnormal buildup of particular acids known as organic acids. Two genes—PCCA and PCCB—are typically mutatedin individuals with PA. Mutations in the TCCA or PCCB gene disrupt the function of the enzyme and prevent the normal breakdown of several amino acids and certain types of fats and cholesterol. As a result, a substance called propionyl-CoA and other potentially harmful compounds can build up to toxic levels in the body. This buildup damages the brain and nervous system, causing the serious health problems associated with propionic acidemia. Treatment of PA typically involves a diet that is low in total protein, as well as several specific amino acids, and is supplemented with L-carnitine and biotin. The treatment regimen itself may result in adverse effects, in part due to the low protein makeup of the diet and individuals on the diet must be carefully monitored.

### SUMMARY

Described herein is a nutritional formula (also referred to as a nutritional formulation) that is an anaplerotic amino acid-organic acid blend that comprises amino acids and organic acids, such as a citric-malate mixture, for the dietary management of individuals in need of management of a disorder of propionate metabolism, such as individuals who have propionic acidemia (PA). The nutritional formula is, in one embodiment, an anaplerotic amino acid-acid blend that provides about 1 G/KG of protein equivalent, such as in an amino acid blend, such as when it is consumed (e.g., in a supplement) as 0.25 G/KG in a drink (e.g., in 4-6 ounces of a flavored drink consumed alone or with food, such as a meal). The nutritional formula can comprise, for example, amino acids; organic acids (e.g., anaplerotic organic acids), such as any one or more of citrate, such as sodium citrate or potassium citrate, citric acid and malic acid or any combination of two or more of them; and, optionally, carnitine (carnitine, acetyl-L-carnitine, such as acetyl-L-carnitine hydrochloride or both carnitine and acetyl-L-carnitine) creatine or both carnitine carnitine, acetyl-L-carnitine, such as acetyl-L-carnitine hydrochloride or both carnitine and acetyl-L-carnitine) and creatine. It can further comprise, if desired, additional components, such as flavoring (e.g., lemon, lime, other fruit), sweeteners, stabilizers, thickening agents. The nutritional formula can he in a variety of forms, such as a powder or a liquid. The formulas are useful to reduce plasma isoleucine and valine concentration on an extended basis; reduce or prevent depletion of CNS methionine and threonine; increase plasma leucine and phenylalanine concentrations (e.g., to the upper range of normal); and increase flux of amino acids and citrate through citric acid cycle anaplerotic pathways to sustain succinyl-CoA and Complex-II activities.

In some embodiments, the nutritional formula for dietary management of individuals in need of management of such a disorder comprises at least one (one or more) of the following organic acids: sodium citrate, potassium citrate, citric acid and malic acid. The nutritional formula can comprise two, three or four of these organic acids in any combination (e.g., sodium citrate in combination with potassium citrate or citric acid or malic acid; sodium citrate in combination with potassium citrate and citric acid; sodium citrate in combination with citric acid and malic acid; sodium citrate in combination with potassium citrate, citric acid and malic acid; potassium citrate in combination with sodium citrate and citric acid; potassium citrate in combination with citric acid and malic acid; citric acid in combination with sodium citrate and potassium citrate; citric acid in combination with potassium citrate and malic acid; citric acid in combination with malic acid and sodium citrate; malic acid in combination with sodium citrate and potassium citrate; malic acid in combination with sodium citrate and citric acid; malic acid in combination with potassium citrate and citric acid; malic acid in combination with sodium citrate and potassium citrate). In a specific embodiment, there is no added citric acid.

In a specific embodiment, the nutrition formula is an anaplerotic amino acid and acid blend that comprises a (at least one, one or more) protein equivalent source, carnitine, creatine, carbohydrates (e.g. sweetener, such as sugar), organic acid(s) (e.g., at least one of sodium citrate, potassium citrate, citric acid, malic acid) and one or more vitamins, In a specific embodiment, the nutrition formula comprises amino acids and vitamins, such as L-alanine, L-arginine, L-aspartic acid, L-asparagine, L-cysteine, creatine, L-glutamic acid, L-glutamine, glycine, L-histidine, L-lysine, L-methionine, L-phenylalanine, L-proline, L-serine, L-threonine, L-tryptophan, L-tyrosine, L-valine, acetyl L-carnitine, taurine, biotin, methyl B12, folic acid, calcium pantothenate, riboflavin (e.g., riboflavinphosphate), and niacin.

In a specific embodiment, the nutritional formula comprises L-Lysine Acetate, L-Asparagine Monohydrate, L-Leucine, L-Arginine, L-Glutamine, L-Phenylalanine, L-Aspartic Acid, L-Alanine, L-Histidine, L-Tyrosine, L-Proline, L-Serine, L-Glutamic Acid, L-Cysteine, L-Methionine, L-Tryptophan, L-Threonine, Glycine, and Taurine, Vitamin cofactors can also be administered and typically will be administered. They are not dosed per kilogram, but are administered in pharmacological doses in all age groups. They can be, for example, any of the following or a combination of any two or more of the following: biotin, vitamin B12, folate, riboflavin, niacin, Coenzyme Q, and vitamin E.

In one embodiment, the nutritional formula comprises or consists essentially of, per 100 gram serving: 330-365 calories (no, or essentially no, calories from fat), 44-49 g protein equivalent, 61-68 g free amino acids, 18-20 g carbohydrates, 18-20 g sugars, 8-10 mg riboflavin, 8-10 mg niacin (B3), 1750-1945 μg folic acid, 1755-1945 μg vitamin B12. 9-10 mg pantothenic acid (B5), 8795-9725 μg biotin, 2199-2430 mg methionine, 1319-1458 mg threonine, 1319-1458 mg valine, 4-5 g acetyl-carnitine, 4-5 g creatine, 21-24 mEq malic acid, 65-73 mEq citrate and 437-483 mg taurine. In additional embodiments, the nutritional formula comprises or consists essentially of, per 100 gram serving: 330-365 calories (no, or essentially no, calories from fat), 44-49 g protein equivalent, 61-68 g free amino acids, 18-20 g carbohydrates, 18-20 g sugars, 8-10 mg riboflavin, 8-10 mg niacin (B3), 1750-1945 μg folic acid, 1755-1945 μg vitamin B12, 9-10 mg pantothenic acid (B5), 8795-9725 μg biotin, 2199-2430 mg methionine, 1319-1458 mg threonine, 1319-1458 mg valine, 4-5 g acetyl-carnitine, 4-5 g creatine, 21-24 mEq malic acid, 65-73 mEq citrate, 437-483 mg taurine and no, or essentially none, of the following: dietary fiber, fat, saturated fat, trans fat, cholesterol, sodium, isoleucine.

In another embodiment, the nutritional formula comprises or consists essentially of, per 100 gram serving, 313-383 calories (no, or essentially no, calories from fat), 41-51 g protein equivalent, 57-71 g free amino acids, 17-21 g carbohydrates, 17-21 g sugars, 8-10 mg riboflavin, 8-10 mg niacin (B3), 1666-2037 μg folic acid, 1666-2037 μg vitamin B12, 8-10 mg pantothenic acid (B5), 8333-10185 μg biotin, 2083-2546 mg methionine, 1250-1528 mg threonine, 1250-1528 mg valine, 4-5 g acetyl-carnitine, 4-5g of creatine, 20-25 mEq malic acid, 62.1.-75.9 mEq citrate and 414-506 mg taurine. In a further embodiment, the nutritional formula comprises or consists essentially of, per 100 gram serving, 313-383 calories (no, or essentially no, calories from fat), 41-51 g protein equivalent, 57-71 g free amino acids, 17-21 g carbohydrates, 17-21 g sugars, 8-10 mg riboflavin, 8-10 mg niacin (B3), 1666-2037 μg folic acid, 1666-2037 μg vitamin 1312, 8-10 mg pantothenic acid (B5), 8333-10185 μg biotin, 2083-2546 mg methionine, 1250-1528 mg threonine, 1250-1528 mg valine, 4-5 g acetyl-carnitine, 4-5g of creatine, 20-25 mEq malic acid, 62.1-75.9 mEq citrate, 414-506 mg taurine and no, or essentially none of the following: dietary fiber, fat, saturated fat, trans fat, cholesterol, sodium, isoleucine.

In a specific embodiment the nutritional formulation comprises or consists essentially of the following:

| NUTRIENTS | per 54 g serving | per 100 g serving |
|---|---|---|
| Calories | 188 | 348 |
| Calories from fat | 0 | 0 |
| Protein equivalent, g | 25 | 46 |
| Free amino acids, g | 34.8 | 64 |
| Carbohydrates, g | 10 | 19 |
| Sugars, g | 10 | 19 |
| Dietary fiber, g | 0 | 0 |
| Fat, g | 0 | 0 |
| Saturated fat, g | 0 | 0 |
| Trans fat, g | 0 | 0 |
| Cholesterol, mg | 0 | 0 |
| Riboflavin (B2), mg | 5.0 | 9.3 |
| Niacin (B3), mg | 5.0 | 9.3 |
| Folic acid, mcg | 1000.0 | 1851.9 |
| Vitamin B12, mcg | 1000.0 | 1851.9 |
| Pantothenic acid (B5), mg | 5.0 | 9.3 |
| Biotin, mcg | 5000.0 | 9259.3 |
| Sodium, mg | 0.0 | 0.0 |
| Isoleucine, mg | 0.0 | 0.0 |
| Methionine, mg | 1250.0 | 2314.8 |
| Threonine, mg | 750.0 | 1388.9 |
| Valine, mg | 750.0 | 1388.9 |
| Acetyl-carnitine, g | 2.5 | 4.6 |
| Creatine, g | 2.5 | 4.6 |
| Malic acid, mEq | 12.5 | 23.0 |
| Citrate, mEq | 37.2 | 69.0 |
| Taurine, mg | 250 | 460 |

The formulation described herein can be produced using methods known to those of skill in the art.

In some embodiments, the nutritional formulation is produced as a powder or a liquid. In some embodiments, the liquid is water, milk, a sport drink, fruit juice (e.g., apple, orange, cranberry, grape, grapefruit, pomegranate, pear) or any other potable liquid. In some embodiments, the nutritional formula is administered to an infant. In other embodiments, it is administered to a toddler. In still other embodiments, it is administered to an adolescent. In further embodiments, it is administered to an adult.

In some aspects, the disclosure relates to methods for dietary management of a disorder of propionate metabolism in a subject in need thereof, the method comprising administering to an individual having propionic acidemia a low protein diet comprising an anaplerotic amino acid-organic acid blend that comprises amino acids and organic acids that increase flux into one or more citric acid cycle anaplerotic pathways.

In some aspects, the disclosure provides a method of dietary management of propionic acidemia, comprising administering to an individual with propionic acidemia a low protein diet comprising an anaplerotic amino acid-organic acid blend that comprises amino acids and organic acids that increase flux into one or more citric acid cycle anaplerotic pathways.

In some embodiments,the disorder of propionate metabolism is propionic academia (PA).

### BRIEF DESCRIPTION OF THE FIGURES

FIG. 1 is a graph showing that methylcitrate production decreases as plasma isoleucine concentration decreases.

FIG. 2 is a graph showing there is no correlation between 2-methylcitrate excretion and plasma methionine and threonine levels.

FIG. 3 is a graph showing the amount of different amino acids in the control and treated groups.

FIG. 4 is a graph showing that the left ventricular ejection fraction improves with treatment.

FIG. 5 are two graphs showing the correlation between methylcitrate production and plasma isoleucine (top graph), and the lack of correlation between methylcitrate excretion and plasma methionine and threonine (bottom graph).

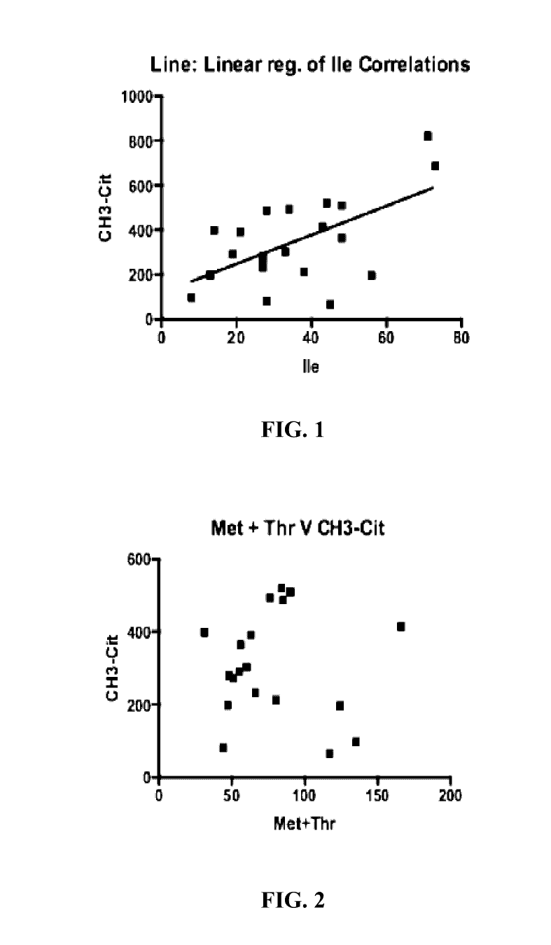

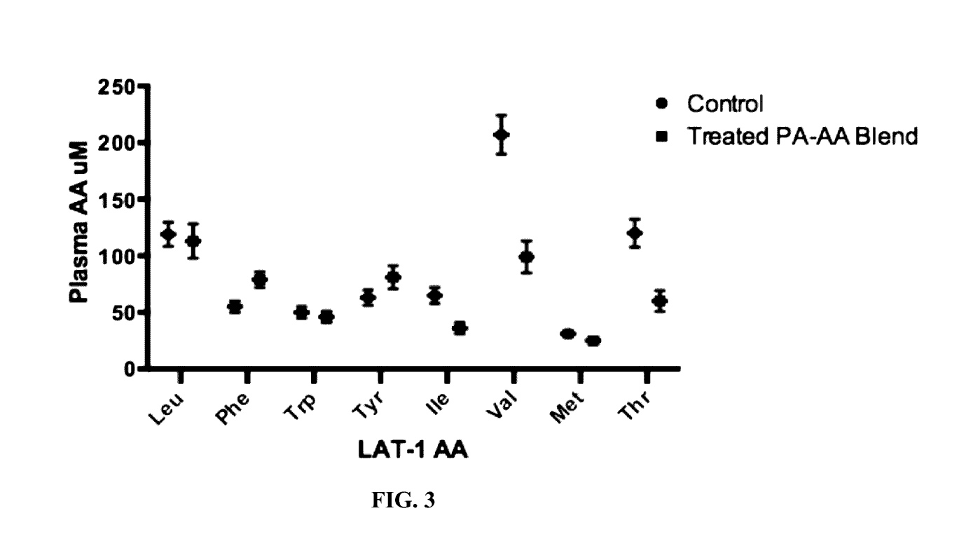

### DETAILED DESCRIPTION

### Propionic Acidemia

Propionic acidemia (PA) is generally detected during the early neonatal period and presents with progressive encephalopathy. Newborns experience symptoms such as poor feeding, vomiting, dehydration, acidosis, low muscle tone, seizures, and lethargy. Death can result from secondary hyperammonemia, infection, cardiomyopathy, or basal ganglial stroke. It is caused by mutations in both copies of PCCA or PCCB genes, which responsible for the formation of propionyl-CoA carboxylase (PCC).

Typically, propionyl CoA carboxylase (PCC) converts propionyl CoA to methylmalonyl CoA as part of the citric acid cycle and gluconeogenesis, ultimately resulting in the conversion of certain amino acids and fats into sugar for energy. Individuals with PA have dysfunctional/nonfunctional propionyl CoA carboxylase, and as a result, isoleucine, valine, threonine, methionine, and odd-chain fatty acids are converted to propionyl CoA. The resulting propionyl CoA is converted into propionic acid (instead of methylmalonyl CoA), which builds up in the bloodstream, leading to an accumulation of acids and toxins and damage to the brain, heart, and liver, seizures, and developmental delays.

PA is managed with a defined protein and calorie diet; protein restriction is essential to positive outcomes. An individual with PA should follow a low protein diet in which the amino acid profile is carefully designed. A low protein diet can, provide, for example, about 1.0-2.0 g/kg body weight/day and is designed to limit the amount of isoleucine, valine, threonine, and methionine in the affected individual. In addition, patients can receive L-carnitine treatment (100 mg/kg/day), biotin supplementation (10 mg/day), and a monthly course of antibiotics to remove intestinal propiogenic flora.

### Citrate Therapy

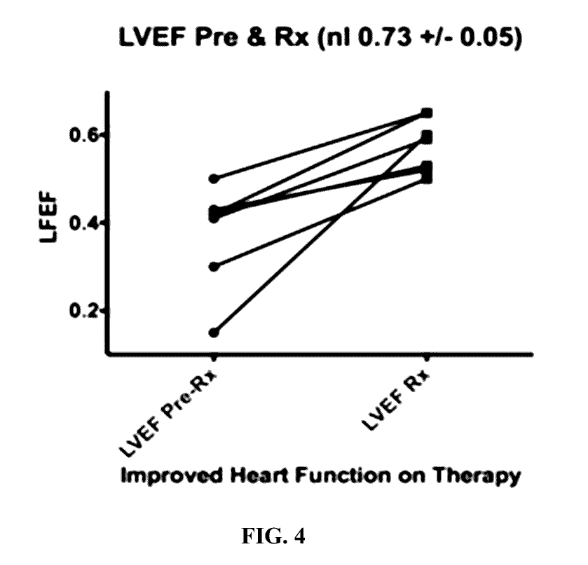

Citrate therapy is routinely used to prevent kidney stones by increasing urine citrate, urine and blood pH, and to manage renal tubular acidosis. Citric acid is transported into mitochondria, where it is metabolized to carbon dioxide and water, effectively removing hydrogen ions and increasing blood pH. Citrate is anaplerotic for the citric acid cycle; methylcitrate synthesis from propionyl-CoA depletes free oxaloacetate and forms an anti-metabolite that slows the conversion of citrate to 2-keto-glutarate and succinyl-CoA. Propionyl-CoA competes with succinyl-CoA to form 3-OH-propionate and with acetyl-CoA for oxaloacetate to form 2-methylcitrate. Restoration of the plasma C3-carnitine/C2-carnitine ratio may help to restore the mitochondrial propionyl-CoA/mt-acetyl-CoA ratio, increasing the citrate/methylcitrate ratio, reflecting sustained synthesis of citric acid. Citrate therapy, therefore, helps to restore the function of the citric acid cycle and suppress acidemia. Malate and malic acid can be used in a similar manner. Patients with PA in heart failure have low citrate-to-methylcitrate ratios. Treatment that normalizes the ratio is associated with improved left ventricular ejection fractions (LVEF) (FIG. 4) and improved overall survival.

The implicated essential amino acids, isoleucine, valine, threonine, and methionine, are not interchangeable, and have different effects. Treatments that chronically deprive the brain of the four amino acids will not improve the metabolic control of PA, and will contribute to poor neurological outcomes. It has been found that isoleucine, representing 5% of dietary protein by weight, has a high affinity for the LAT1 transporter at the blood-brain barrier, and therefore is a major source the propionyl-CoA and methylcitrate in the brain and heart. In comparison, valine is also 5% of dietary protein by weight, but has a much lower affinity for the LAT1 transporter and contributes little to the toxic metabolites. It is essential for brain growth and development. Methionine is only 1% of dietary protein by weight, makes few of the toxic metabolites, but is involved in hundreds of essential chemical reactions in the brain. Its depletion in the central nervous system results in poor brain growth and progressive microcephaly, seizures, delayed development, and autistic-like behavior.

### Cobalamin C Deficiency

Cobalamin C defects are the most common inborn cobalamin metabolism errors, causing impaired conversion of dietary vitamin B 12 into methylcobalamin and adenosylcobalamin, its two metabolically active forms. An accumulation of methylmalonic acid and homocysteine results, and synthesis of methionine is decreased. The defect results from one of over 40 identified mutations in the MMACHC gene. Patients' symptoms and the severity of the disease range greatly; early-onset patients exhibit a multisystem disease, with severe neurological, ocular, hematological, renal, gastrointestinal, cardiac, and pulmonary symptoms, while late-onset patients have a milder clinical phenotype, with acute or slowly progressive neurological symptoms and behavioral disturbances. Treatment generally includes a combined approach, using vitamin B 12 to increase intracellular cobalamin, which maximizes deficient enzyme activities, betaine to facilitate the conversion of homocysteine into methionine, and folic acid to improve the remethylation pathway. Individuals undergoing treatment with medical foods designed for isolated methylmalonic acidemia are at risk for iatrogenic methionine deficiency that may adversely affect brain growth and development, and thus, there is a need for better-suited medical foods for such patients.

### Nutritional Formula

Therapy for PA aims to reduce propionyl-CoA in the brain by restricted dietary protein intake, carnitine conjugation, and amino acid blends that selectively influence LAT1 transport. This approach can have detrimental effects, however, if, for example, essential amino acids are over restricted. The nutritional formula described here and its use are designed, in one embodiment, to decrease the plasma levels of isoleucine using natural protein restriction, modestly decrease levels of valine and threonine, and preserve methionine concentration and transport in order to maintain a more physiological balance. Isoleucine uptake in the brain can also be reduced by increasing plasma leucine, methionine, and valine, which means that these amino acids are available for brain growth and function.

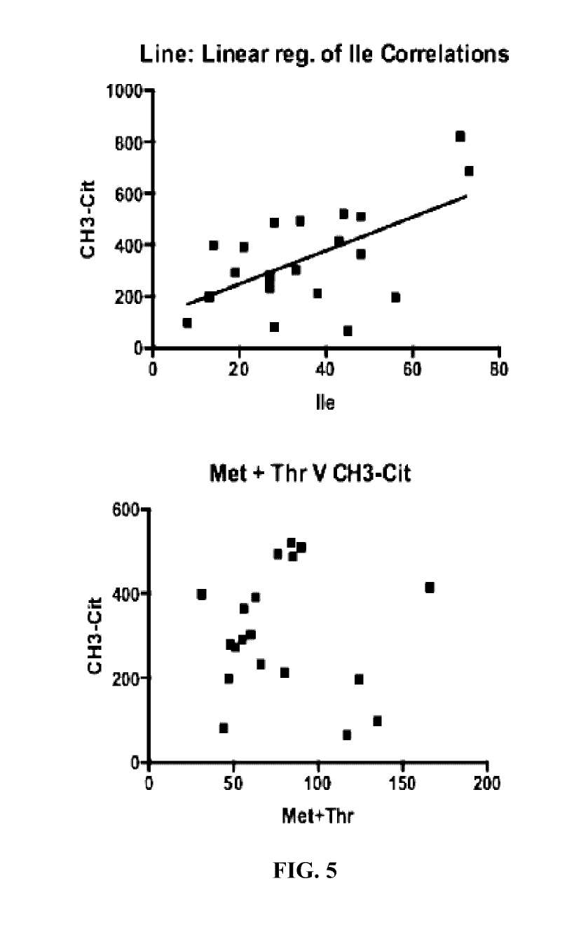

In PA, propionyl-CoA competes with acetyl-CoA for oxaloacetate to form methylcitrate. Methylcitrate production decreases as plasma isoleucine concentration decreases; however, there is no correlation between methylcitrate excretion and plasma methionine and threonine (FIG. 5).

Malic acid and citric acid are useful components in the management of errors of propionate metabolism, such as propionic acidemia. Both are alkalizing metabolites and reduce the concentration of hydrogen ions in the blood without donating ammonia. Additionally, citrate, the conjugate base of citric acid, is involved in the physiological oxidation of acetate from fats, proteins, and carbohydrates, which is later converted to intracellular energy (adenosine triphosphate, ATP) as part of the citric acid cycle.

In one embodiment, the nutritional formulation is in powder form, which can be taken as a powder or combined with a liquid or an edible nonliquid. It can be taken alone or with meals to modulate the affected individual's metabolism.

In some embodiments, the nutritional formula may be dissolved in a liquid, such as water, fruit juice (e.g., apple, orange, cranberry, grape, grapefruit, pomegranate, pear), sports drinks, milk or other potable liquid.

In another embodiment, the formulation is added to milk, such as human milk or other milk (cow, goat, sheep, for example) or infant formula to increase the amino acid content and total protein equivalent as a means to modify the amino acid profile of the milk or formula, and to increase the total protein of the human milk or infant formula. For example, the prescribed weight of the powder can be dissolved in 4 ounces of liquid, such as 4 ounces of lemon, lime or orange sports drink, other citrus-flavored water or a juice, such as apple juice. The resulting beverage can be consumed with a low-protein meal or as a bed-time snack. In one embodiment described here, the total protein equivalent per day is 0.5-1.0 g/kg weight divided over 3-4 doses.

The nutritional formula is used to modulate the uptake of specific amino acids into the brain. Further versions of the formula can be used to decrease isoleucine uptake while increasing one or more of the following amino acids: leucine, methionine, and valine.

### EXAMPLE

Clinic observations of 69 Amish and Mennonite children and adults, homozygous for PCCB c.1606A>G—one of the common inherited biochemical disorders in Plain populations in the US.

Propionic acidemia (PA) management aims to reduce propionyl-CoA in the brain by restriction of dietary protein, carnitine-C3 conjugation, and amino acid blends that modulate plasma amino acid concentrations and LAT1 transport across the blood-brain barrier. However, the restriction of LAT1-dependent Met-Thr-Val can be detrimental to brain growth and function. Amino acids and citrate support the mitochondrial repletion of succinyl-CoA. It is thought that succinyl-CoA dehydrogenase/Complex-II is impaired in variants of PA, MMA and Cobalamin-C.

### Methods

Amino acids were quantified by OPA-HPLC, methylcitrate and citrate by GC/MS. Lab work was CLIA-certified and observations about PA natural history and biochemistry were made under IRB approval. Comparisons included urine methylcitrate and citrate/methylcitrate ratios compared with plasma Ile-Val- Thr-Met levels and calculated LAT1-dependent flux. In-Vitro Kinetic-Flux-Profiling used LC-Q-Exactive-MS-detection.

### Experimental Groups

A non-treatment group of historical controls included 51 patients on self-selected low protein diets. The treatment group included five neonates managed over 4 years and 13 children and adults (median age, 11 years; range, 4-32 years). Dietary protein intake was 1 g/kg-d (range 0.3-1.7), carnitine 25-100 mg/kg-d, PA-Amino Acid Supplements 0.5-1 g/kg-d, and citrate 0.5-1 mEq/kg-d. The patients' growth, exams, CBCs, chemistries, plasma amino acids and calculated LAT1-transport, urine methylcitrate/creatinine ratios, urine citrate/methylcitrate ratios, LV ejection and shortening fractions, and QTc by EKG, were examined.

### Results

In vitro results showed that isoleucine is the predominant source of propionylcarnitine. MMA patient-derived (MUT⁰ GM-00050) and wild-type-MUT fibroblasts (HFF1) were exposed to stable isotope-labeled nutrients, including ¹³C¹⁵N-Leu, -Ile, -Val, and -Met. Across both genotypes, the rate of ¹⁵N incorporation into glutamate indicated that both leucine and isoleucine were preferentially utilized by branched chain amino acids to a greater extent than valine. This preferential catabolism, Ile>>Val, is mimicked by ¹³C₃-propionylcarnitine, where the ratio of Ile-to-Val-derived carbon ranges from 11- to 13-fold across the two genotypes. Isoleucine appears to be the principle source of propioinyl-CoA in muscle and the brain. Reduced dietary isoleucine intake, lower plasma isoleucine concentrations, and low isoleucine-LAT1 transport correlated with reduced urine methylcitrate excretion.

In the untreated patients, mortality was high (9 of 51 (18%) patients), and one heart transplant was performed. Two-thirds of the cardiac deaths were from dilated cardiomyopathy and ⅓ were from sudden cardiac death, which was probably associated with long QTc. The patients' ages at death ranged from 2 to 24 years. Neurological outcomes were also poor: seizures associated with illness were common. In some cases, recurrent seizures evolved into intractable epilepsy, dystonia arising from internal globus pallidus degeneration, and poor school performance associated with attention-deficit/hyperactivity syndrome. Cardiomyopathy, lethal arrhythmias, seizures, encephalopathy, metabolic strokes and cognitive decline occurred at all ages, with or without keto-acidotic crisis. Hyperammonemia was not reported.

Treated patients fared better; cardiomyopathy improved or stabilized in all patients. There were no cardiac deaths or heart transplants. Seizures were rare, and no patient developed epilepsy. The patients' growth and exams were normal. Children attended school in normal classes and earned marks similar to their siblings and parents. Formal IQ-testing was not performed.

### Conclusions

PCCB c.1606A>G is not a benign variant of PA. The treatment described improves cardiac and neurological outcomes. Mixtures of amino acids and citric acid were designed to increase flux into citric acid cycle anaplerotic pathways to sustain succinyl-CoA/Complex II activity. The urine citrate-to-methylcitrate ratio was used as a biomarker; ratios >2 were associated with metabolic stability, while those <1 were associated with illnesses, including cardiomyopathy. The PA-AA acids blends studied selectively decreased plasma levels of isoleucine and increased plasma levels of leucine and phenylalanine, competitive amino acids at the LAT1 transporter. Valine and threonine were less restricted, preventing chronically low flux into the CNS. Methionine was not restricted. A specific goal of therapy was to maintain normal methionine intake, high-normal methionine plasma levels, and sustained, positive methionine-LAT1 CNS transport values. No correlation was found between variations of threonine and methionine and methylcitrate excretion. The patients treated with the PA-AA blend showed significant increases in phenylalanine and tyrosine, but not in plasma leucine.

Further versions of the amino acid blend administered can include, for example, increases in some or all of leucine, methionine and valine (e.g., increases in leucine, methionine and valine). Decreased Ile-LAT1 uptake into the brain can be effected by small increases in plasma leucine, phenylalanine and valine, which assures that these amino acids are available for brain growth and development.

1. A nutritional formula that comprises an anaplerotic amino-acid-organic acid blend, for dietary management of individuals in need of management of a disorder of propionate metabolism, such as individuals who have propionic acidemia (PA).

2. The nutritional formula of claim 1, wherein the blend comprises amino acids and organic acids that increase flux into one or more citric acid cycle anaplerotic pathways.

3. The nutritional formula of claim 2, wherein the organic acids are a citric-malate mixture.

4. The nutritional formula of claim 1 wherein the blend does not include added isoleucine.

5. The nutritional formula of claim 1 which is a powder or a liquid.

6. The nutritional formula of claim 1 further comprising one or more vitamins or vitamin cofactors.

7. A nutritional formula that is an anaplerotic amino acid-organic acid blend that comprises or consists essentially of, per 100 gram serving: 330-365 calories wherein no, or essentially no, calories are from fat, 44-49 g protein equivalent, 61-68 g free amino acids, 18-20 g carbohydrates, 18-20 g sugars, 8-10 mg riboflavin, 8-10 mg niacin (B3), 1750-1945 μg folic acid, 1755-1945 μg vitamin B12, 9-10 mg pantothenic acid (B5), 8795-9725 μg biotin, 2199-2430 mg methionine, 1319-1458 mg threonine, 1319-1458 mg valine, 4-5 g acetyl-carnitine, 4-5 g creatine, 21-24 mEq malic acid, 65-73 mEq citrate and 414-506 mg taurine.

8. The nutritional formula of claim 7 wherein the nutritional formula comprises or consists essentially of, per 100 gram serving, no, or essentially none, of the following: dietary fiber, fat, saturated fat, trans fat, cholesterol, sodium, or isoleucine.

9. A nutritional formula that comprises or consists essentially of, per 100 gram serving, 313-383 calories wherein no, or essentially no, calories are from fat, 41-51 g protein equivalent, 57-71 g free amino acids, 17-21 g carbohydrates, 17-21 g sugars, 8-10 mg riboflavin, 8-10 mg niacin (B3), 1666-2037 μg folic acid, 1666-2037 μg vitamin B12, 8-10 mg pantothenic acid (B5), 8333-10185 μg biotin, 2083-2546 mg methionine, 1250-1528 mg threonine, 1250-1528 mg valine, 4-5 g acetyl-carnitine, 4-5g of creatine, 20-25 mEq malic acid,62.1-75.9 mEq citrate and 414-506 mg taurine.

10. The nutritional formula of claim 9, wherein the nutritional formula comprises or consists essentially of, per 100 gram serving, no, or essentially none of the following: dietary fiber, far, saturated fat, trans fat, cholesterol, sodium, or isoleucine.

11. The nutritional formula of claim 1, wherein the formula is a powder dissolved in a liquid and the liquid is water, fruit juice selected from apple, orange, cranberry, grape, grapefruit, pomegranate, or pear, a sports drink, or milk.

12. A method of dietary management of a propionate metabolism disorder, comprising administering to an individual in need of dietary management of a propionate metabolism disorder the nutritional formula of claim 1.

13. A method of dietary management of propionic acidemia, comprising administering to an individual with propionic acidemia a low protein diet comprising an anaplerotic amino acid-organic acid blend that comprises amino acids and organic acids that increase flux into one or more citric acid cycle anaplerotic pathways.

14. The method of claim 13, wherein the anaplerotic amino acid-organic acid blend does not include added isoleucine.

15. The method of claim 12, wherein the anaplerotic amino acid-organic acid blend contains methionine and methionine is administered in sufficient amount to maintain normal intake and produce high-normal plasma methionine levels.

16-22. (canceled)
